(19) United States
(12) Patent Application Publication
(10) Pub. No.: US 2007/0079915 A1
(43) Pub. Date: Apr. 12, 2007

(54) Cluster trac 4 season radial technical field

(76) Inventor: Vivian C. Jones, Lubbock, TX (US)

Correspondence Address: KENNETH D. BAUGH, 2413 BLODGETT, HOUSTON, TX, 77004, US

(21) Appl. No.: 11/442,913

(22) Filed: May 30, 2006

Related U.S. Application Data
(60) Provisional application No. 60/724,769, filed on Oct. 7, 2005.

(51) Int. Cl. B60C 27/00

(52) U.S. Cl. 152/210

(57) ABSTRACT

A vehicle tire 10 is provided. The tire 10 includes an outermost member 12 having a plurality of spaced aligned apertures 22 formed therethrough. An innermost member 28 is aligned in and adjacent to the outermost member 12. Additionally a plurality of spaced aligned elongated studs 40 are formed in the innermost member 28 in recesses 38 formed therein and aligned in a corresponding one of the apertures in the outermost member. The tire 10 further includes an air inflation member 36 for inflating the innermost member 28 so that the studs 40 formed thereon will move from a retracted recessed position to an extended position through the apertures in the outermost member 12 to provide additional surface traction for the tire.

This application claims priority of Provisional Application Ser. No. 60/724,769 filed on Oct. 7, 2005. This invention relates to a vehicle and more particularly a specific component of the vehicle the tire. The tire of course is a necessary component to facilitate motion on a vehicle. Proper tires contribute to vehicle safety which is very important and is an ongoing and of the utmost concern in today's society. Having a vehicle with a good set of tires is critical to the safety of those who ride in the vehicle. Safety dictated by weather conditions and the seasons is one of the more common concerns. The most common attempt to address this situation is by trying to use tires which are virtually used year round and are designed not to be impacted by the change in seasons. However, these tires don't work under all conditions. Particularly in those geographical regions where weather conditions may vary from one season to another rather drastically. In these geographic regions a set of year round tires are hardly ever sufficient because motorist who live in these regions have to deal with ice and snow covering road surfaces during colder seasons. These motorist have to consider other alternatives to assure and enhance safety. One of the popular alternatives for these motorist is the purchase of metal chains or other such accessories that fit over their tire's treads to provide increased traction and safety. This is a popular alternative because these tire accessories are normally easy to install. However these accessories are not necessarily ideal for snow as well as ice.

### TECHNICAL FIELD

Accordingly it is desirable to have all season tires whose surface can be modified when road surfaces dictate to effectively accommodate all conditions necessitated by the change in weather conditions.

### BACKGROUND ART

Attempts have been made to provide devices to facilitate all season tires. One such device is illustrated in U.S. Pat. No. 5,810,451. In this arrangement a traction device for a vehicle wheel is provided. The wheels of this invention include a traction device for a vehicle which has studs aligned in tread segments that are expandable and contractible by secondary inflatable chambers to place the studs either in engagement or out of engagement with a road surface. Another apparatus is disclosed in U.S. Pat. No. 5,221,379. This invention discloses a retractable tire stud. The retractable tire stud of this invention discloses a stud which includes a hardened pin mounted in a steel jacket and extending therefrom to engage the roadway. The stud is sized for insertion in openings in the tire tread. The pin is retractable into the jacket thereby removing the pin from contact with the road surface and providing non-studded as well as studded service from the same tire. Although these devices may somewhat achieve the desired result these structures may be considered somewhat complex thus the commercial viability remains to be seen. Therefore there is an ongoing need for a tire that is low in cost and structural feasible which provides an all season tire whose surface can be modified when road surfaces dictate.

### DISCLOSURE OF THE INVENTION

A tire for a vehicle is provided The tire of this invention includes an outermost member. The outermost member is provided with a surface engaging member having a plurality of spaced aligned apertures formed therethrough. An innermost member is provided which is aligned in the outermost member adjacent the surface engaging member. A plurality of spaced aligned elongated studs are formed in the innermost member in a retracted recessed position with each one of the plurality of elongated studs aligned in an adjacent corresponding one of the apertures in the surface engaging member of the outermost member. The tire of this invention is also provided with means for facilitating the inflation of the innermost member so that the elongated studs formed thereon will move from the retracted position to an extended position through the apertures in the outermost member. In this extended position outermost portions of the elongated studs are external to the outermost member thereby making good and sure contact with a road surface and increasing the traction between the tire and the road surface.

### BRIEF DESCRIPTION OF THE DRAWING

The details of the invention will be described in connection with the accompanying drawing in which:

FIG. 1 is a perspective view illustrating a tire in accordance with the principles of the invention.

FIG. 2 is a side view of a tire in accordance with the principles of the invention.

FIG. 3 is a partial-sectional view of a tire in accordance with the principles of the invention with a stud of the invention shown in a recessed retracted position.

FIG. 4 is a perspective sectional view of a tire in accordance with the principles of the invention with studs of the invention shown in an extended position.

FIG. 5 is a side view of a tire in accordance with the principles of the invention with the studs of the invention shown in an extended position.

FIG. 6 is a partial-sectional view of a tire in accordance with the principles of the invention with the stud of the invention shown in an extended position.

### BEST MODE FOR CARRYING OUT THE INVENTION

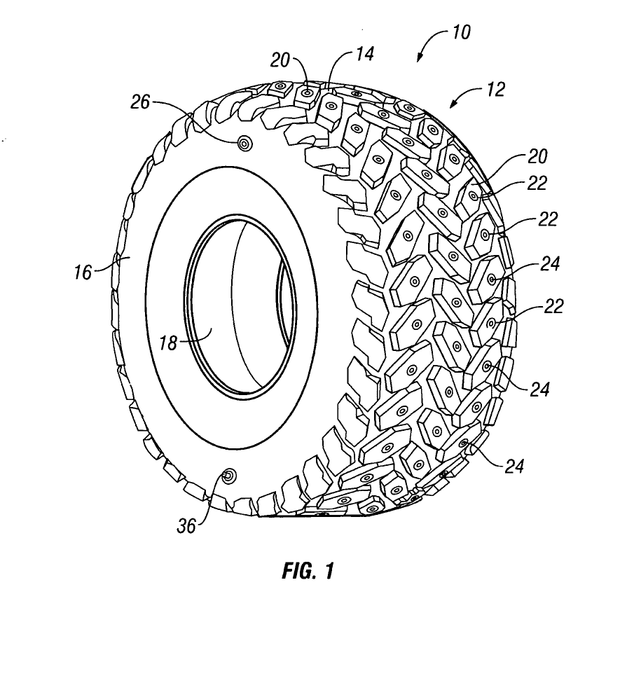

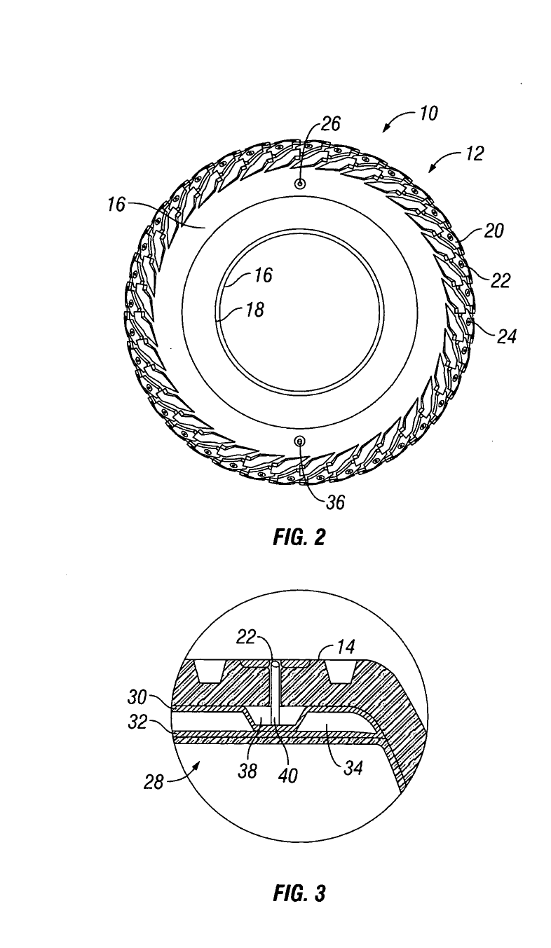

Referring to FIGS. 1 and 2 there is shown, a tire, generally designated, by the numeral, 10. The tire 10 is provided with an outermost body, generally designated, by the numeral, 12. The outermost body 12 is formed with a road surface engaging member 14 with side members 16 (only one shown) extending downwardly from each outermost portion of the surface engaging member. As a result an internal elongated cavity 18 is formed therebetween in a well known manner. The surface engaging member 14 is provided with a plurality of spaced aligned tire tread members 20 which are formed thereon. The thread members are provided to enhance traction with a road surface. Each of the tire tread members 20, is provided with a sealable aperture 22 which extends through the thread member into the cavity 18. The aperture 22 is provided with a seal 24 which opens and closes when necessary to assure an air tight seal for the aperture when appropriate. The outermost body 12 is provided with an inflation valve 26 formed on one of the side members 16. The inflation valve 26 facilitates inflation and deflation of the outermost body 12 so that the tire 10 can function in a well known matter.

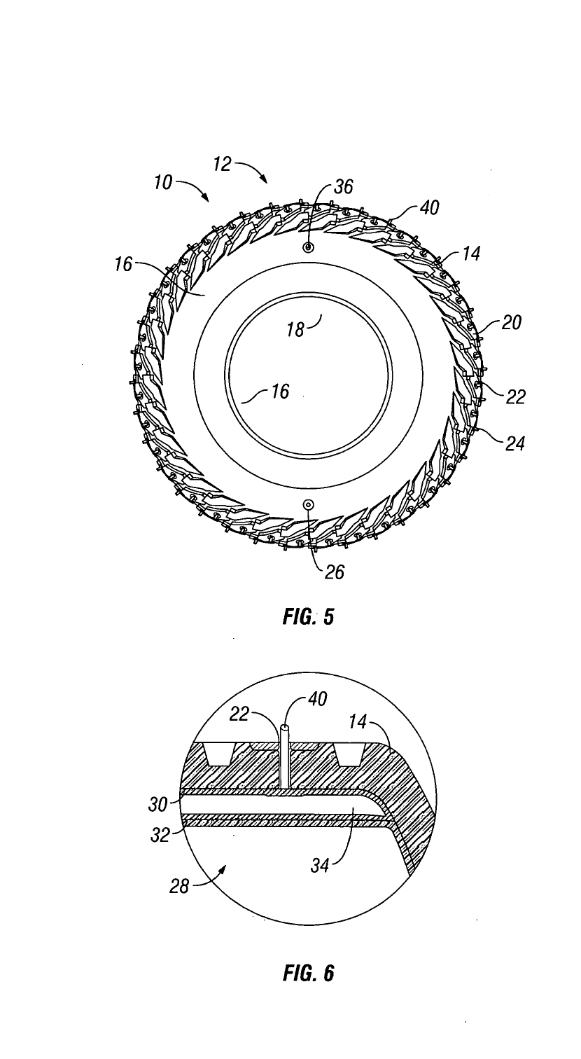

As illustrated in FIGS. 3, 4, 5 and 6 the tire 10 is also provided with an innermost inflatable bladder member, generally designated, by the numeral 28 (FIGS. 3 and 6). The bladder member 28 which is aligned in the cavity 18 of the outermost body 12 is formed with spaced wall members 30 and 32 having an air cavity 34 formed therebetween. An inflation valve 36 is provided which facilitates inflation and deflation of the bladder member 28. The wall member 30 of the bladder member 28 is provided with a plurality of spaced aligned recesses 38 (FIG. 3 only one shown) formed therein. The bladder member 28 is also provided with a plurality of spaced aligned elongated studs 40. A stud 40 is coupled perpendicularly to each one of the recesses 38 in the bladder member 28. The bladder member 28 is aligned in the outermost body 12 so that each one of the studs 40 is aligned in a corresponding one of the plurality of apertures 22 in the surface engaging member 14. The studs 40 are made, for example, of a hard rubber. The studs 40 may, for example, be two inches in length and one inch in diameter. The diameter of the studs 40 is slightly larger than the diameter of the aperture 22 in the outermost body assembly 12.

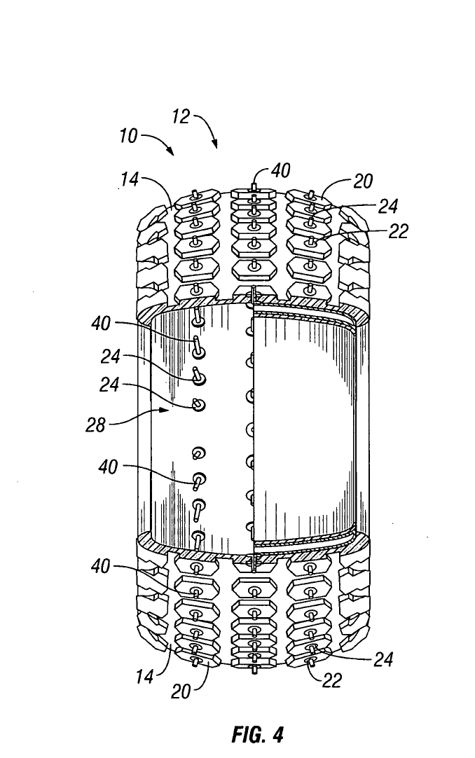

As illustrated in FIGS. 4, 5 and 6 air is injectable into the air cavity 34 of the bladder member 28 through the valve 36. Once air is injected into the bladder member 28, the bladder member 28 is inflated (FIG. 3) thereby causing the retracted recessed studs 40 to move from a retracted position to an extended position. This causes the studs 40 to move through the corresponding aperture 22 in the surface engaging member 14 so that outermost portions of the studs are external to the surface engaging member. This allows the studs 40 to engage a road surface. The air pressure in the air cavity 34 of the bladder member 28 causes the studs 40 to be maintained in the extended position so that they may continue to engage the road surface as long as desired. The diameter of the studs 40 along with the seals 24 facilitate an air tight seal when the studs 40 are in aligned engagement with and extend through the aperture 22. When the studs 40 are in this position they can make good and sure contact with the road surface thereby increasing the traction between the tire 10 and the road surface.

When it is desired to reduce the traction created by the studs 40 the air is removed from the cavity 34 of the bladder member 28 using the valve 36. Once the air is removed from the cavity 34 the studs 40 automatically go back to the retracted recessed position thereby permitting the apertures 22 to be sealed again by seals 24 and allow the tire to function in a normal reduced traction mode.

It should be understood that the invention may be provided with an external elongated air hose and portable air pump to make inflation and deflation of the bladder member easy for a user from outside the vehicle. It is also within the scope of the invention that the inflation and deflation of the bladder member may be accomplished from inside the vehicle automatically by a user.

The invention has been shown and described in what is considered to be the most practical and preferred embodiment. However, it should be recognized that changes may be made by those skilled in the art without departing from the spirit and scope of the invention.

What is claimed:

1. A tire for a vehicle including:
an outermost member having a plurality of spaced aligned apertures formed therethrough;
an innermost member having recesses formed therein aligned adjacent the outermost member;
a plurality of spaced aligned elongated studs, each one of the studs having first portions aligned in coupling engagement in one of the recesses in the innermost member, and another portion thereof aligned in a corresponding adjacent one of the apertures in the outermost member; and
means for facilitating inflation of the innermost member so that the studs formed thereon will move from a recessed position to an extended position in the apertures and so that outermost portions of the stud extend beyond the outermost member.

2. A tire as defined in claim 1 wherein the outermost member further includes a plurality of spaced aligned raised members each having one of the plurality of apertures formed therein.

3. A tire as defined in claim 2 wherein the outermost member includes an air seal formed on an outermost end portion of each of the apertures.

4. A tire as defined in claim 3 wherein the innermost member includes an air cavity.

5. A tire as defined in claim 4 wherein the inflation facilitating means includes:
an air valve which allows air to be injected into the air cavity so that the studs can move from a recessed position to an extended position and which allows air to be removed from the air cavity so that the studs can move from the extended position back to the recessed position.

6. A tire as defined in claim 5 wherein the outermost member includes:
a surface engaging member;
a first side member extending downwardly from first outermost portions of the surface engaging member; and
a second side member extending downwardly from second outermost portions of the surface engaging member so that an elongated cavity is formed between the surface engaging member and the first and second side members.

7. A tire as defined in claim 6 wherein the innermost member is aligned in the cavity in the outermost member.

8. A tire as defined in claim 6 wherein the innermost member includes an inflatable bladder member.

9. A tire as defined in claim 8 wherein the inflatable bladder member includes:
a first wall member having a plurality of spaced aligned recesses formed therein;
a second wall member spaced from and aligned with the first wall member so that an air cavity is formed therebetween.

10. A tire as defined in claim 9 wherein each one of the elongated studs is perpendicularly coupled to a corresponding one of the recesses in the first wall member of the inflatable bladder member.

11. A tire for a vehicle including:
a surface engaging member;
a first side member extending downwardly from outermost portions of the surface engaging member;
a second side member extending downwardly from second outermost portions of the surface engaging member so that an elongated cavity is formed between the surface engaging member and the first and second side members;
a plurality of spaced aligned raised members coupled to the surface engaging member, each one of the spaced aligned raised members having an aperture formed therethrough which extends into the elongated cavity;
an air seal formed in an outermost portion of each of the apertures;
an inflatable bladder having spaced aligned recesses formed on one side thereof aligned in the elongated cavity;
a plurality of elongated studs, each one of the plurality of studs being coupled in a corresponding recess in the inflatable bladder to extend into a corresponding one of the apertures; and
an air inlet for facilitating the inflation of the bladder so that the elongated studs can be moved from a retracted position to an extended position with outermost portions of the elongated studs extended beyond an outside of the surface engaging member.

12. A tire as defined in claim 11 wherein the air inlet further includes means for deflating the bladder so that the studs can be moved from the extended position back to the retracted position.

13. A tire as defined in claim 12 wherein each one of the elongated studs is perpendicularity coupled to a corresponding one of the recesses in the inflatable bladder member.
